(19) United States
(12) Patent Application Publication
(10) Pub. No.: US 2024/0170752 A1
(43) Pub. Date: May 23, 2024

(54) Method For Recovering Valuable Metallic Components From A Solution Containing The Same

(71) Applicant: SOGANG UNIVERSITY RESEARCH & BUSINESS DEVELOPMENT FOUNDATION, Seoul (KR)

(72) Inventors: Jong Suk LEE, Seoul (KR); Cheol Hun YOO, Gyeonggi-do (KR); Jeong Han SHIN, Seoul (KR); Ho Jun LEE, Seoul (KR)

(21) Appl. No.: 18/515,719

(22) Filed: Nov. 21, 2023

(30) Foreign Application Priority Data
Nov. 22, 2022 (KR) 10-2022-0156855

(51) Int. Cl. H01M 10/54; C22B 3/22; C22B 3/44

(52) U.S. Cl. CPC H01M 10/54; C22B 3/22; C22B 3/44

(57) ABSTRACT

A method is provided for selectively recovering and concentrating valuable metal ions using diafiltration and nanofiltration from a solution containing the valuable metal ions and impurity metal ions. It is possible to selectively recover and concentrate valuable metal ions from a solution containing the valuable metal ions and impurity metal ions by the method.

### CROSS REFERENCE TO RELATED APPLICATIONS

This application claims priority to Korean patent application no. 10-2022-0156855 filed on Nov. 22, 2022, which is expressly incorporated by reference herein in its entirety.

### BACKGROUND

### Technical Field

The present invention relates to a method for recovering valuable metallic components from a solution containing the same. Specifically, the present invention relates to a method for selectively recovering and concentrating valuable metal ions using diafiltration and nanofiltration from a solution containing a low concentration of the valuable metal ions and a high concentration of impurity metal ions.

### Background Art of the Invention

Recently, as the electronics and battery industries have grown rapidly, environmental pollution problems caused by various wastes containing heavy metals and unstable supply and demand of various resources required for the industry have emerged as major challenges for the industry. To solve these problems, there is an urgent need to develop a technology to recover and recycle valuable metals contained in industrial waste solutions discharged from the manufacturing process of various electronic products such as batteries and displays.

However, there are many difficulties in such a recycling process, one of which is the problem of performance deterioration in the separation process due to high concentration of impurity ions. That is, the conventional technologies for recovering valuable metals, such as solvent extraction, adsorption, or membrane separation, have a disadvantage in that the separation efficiency of valuable metal ions is significantly reduced by the increase in ion concentration and ionic strength due to the high concentration of impurity ions. For the adsorption-based separation and purification technology, it has been reported that the adsorption of impurity ions has an adverse impact on the adsorption performance of the adsorbent for valuable metal ions (see non-patent documents 1 to 3). In addition, the separation membrane technology utilizing nanofiltration has a significant limit in permeate discharge due to the increase in osmotic pressure caused by high-concentration impurity ions, making it difficult to concentrate valuable metal ions (see FIG. 1).

In reality, in waste solutions discharged from a manufacturing process of cathode material, which is one of the industrial waste solutions, nickel, one of the major valuable metals, is contained in a significant amount at a concentration of 1,000 ppm. However, since a large amount of sodium hydroxide is used during the manufacturing process, a large amount of sodium ions are present in the solution, whose concentration reaches 20,000 ppm. This level is sufficient to reduce the efficiency of the separation and purification process.

To solve this problem, various processes have been developed to selectively separate ions, but all of them have various technical problems for commercialization. For example, for electrodialysis using an ion exchange membrane, the unit cost of materials to construct the facility is very expensive. For nanofiltration, the rejection of impurity ions varies greatly depending on the type of counter ions, making it difficult to selectively remove only impurity ions. In addition, when a high concentration of impurity ions is present, energy efficiency is reduced or the process itself is difficult to be operated due to high osmotic pressure (see FIG. 2).

### PRIOR ART DOCUMENTS

### Non-Patent Document

(Non-patent Document 1) Ghodbane, Ilhem, et al., Journal of Hazardous Materials, 152.1 (2008): 148-158
(Non-patent Document 2) Alvarez-Ayuso, E., and A. García-Sánchez, Journal of Hazardous materials, 147.1-2 (2007): 594-600
(Non-patent Document 3) Xu, Di, Xiang Zhou, and Xiangke Wang, Applied Clay Science, 39.3-4 (2008): 133-141

### DISCLOSURE OF THE INVENTION

### Technical Problem to Be Solved

An object of the present invention is to provide a method for selectively recovering and concentrating valuable metal ions from a solution containing the valuable metal ions and impurity metal ions.

### Solution to the Problem

According to an embodiment of the present invention, there is provided a method for selectively recovering and concentrating valuable metal ions, which comprises (1) adding a water-soluble polymer to a solution containing valuable metal ions and impurity metal ions to form a polymer-ion complex in which the valuable metal ions and the polymer are combined; (2) conducting diafiltration on the solution containing the polymer-ion complex and the impurity metal ions to have the impurity metal ions selectively penetrated and removed; (3) adding an acid to the polymer-ion complex solution from which the impurity metal ions have been removed to decomplex the water-soluble polymer and the valuable metal ions; (4) conducting diafiltration on the solution containing the water-soluble polymer and the valuable metal ions that have been decomplexed to have the valuable metal ions selectively penetrated and recovered; and (5) concentrating the recovered valuable metal ions through a nanofiltration process.

### Advantages Effects of the Invention

It is possible to selectively recover and concentrate valuable metal ions from a solution containing the valuable metal ions and impurity metal ions by the method for selectively recovering and concentrating valuable metal ions according to an embodiment of the present invention.

### BRIEF DESCRIPTION OF THE DRAWINGS

FIG. 1 shows a decrease in the water permeance of a feed solution containing a high concentration of salt ions due to an increase in osmotic pressure caused by an increase in the concentration of sodium salts in a solution when valuable metal ions are concentrated through a nanofiltration process.

FIG. 2 shows an increase in energy consumption and time consumption as the concentration of sodium salts in a solution increases when nickel ions are concentrated through a nanofiltration process.

FIG. 3 is a flow chart of a method for recovering valuable metal ions from a solution according to an embodiment of the present invention.

FIG. 4 shows that the changes in the concentration of nickel ions and sodium ions with respect to diavolume as a solution containing nickel sulfate and sodium sulfate salts undergoes diafiltration.

FIG. 5 shows the yield and purity of nickel after diafiltration to remove sodium ions.

FIG. 6 shows the concentration of nickel before and after decomplexation.

FIG. 7 shows the concentration of a solution obtained by adding an acid to a solution containing a polymer-ion complex for decomplexation thereof and the changes in the concentration and recovery rate of the total permeate solution with respect to diavolume according to the progress of diafiltration.

FIG. 8 shows the change in the concentration and yield of a nickel solution with respect to the concentration ratio.

FIG. 9 shows a process diagram of the diafiltration process in Example 1.

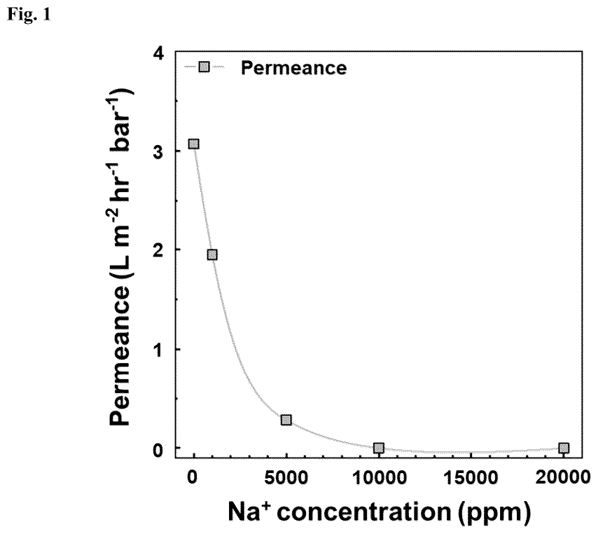

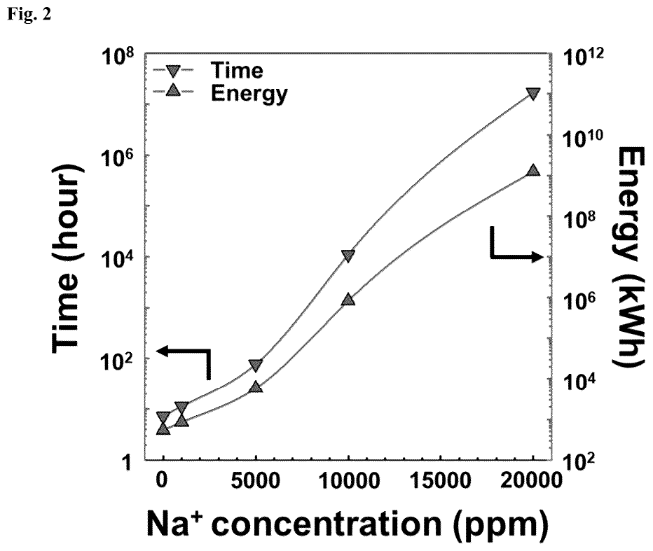

### DETAILED DESCRIPTION FOR CARRYING OUT THE INVENTION

Hereinafter, the present invention is explained in more detail.

In the present specification, “polymer-ion complex” refers to a form in which a polymer and a valuable metal ion behave as a single particle due to strong interaction forces exerted by chemical bonds such as coordination bonds or physical forces such as electrostatic forces.

In the present specification, “ultrafiltration membrane” refers to a semi-permeable membrane of organic or inorganic components that has a pore size of 2 nm or more and has a sieving function that allows chemical species or ions with small molecular weights to easily pass through while suppressing the penetration of macromolecules with relatively large molecular weights.

In the present specification, “diafiltration” refers to a special form of a membrane filtration process that is carried out by continuously adding the same volume of a buffer as that of the permeate to the retentate phase of a membrane process while maintaining constant the internal atmosphere of the solution such as volume of the retentate phase, pH, and polymer concentration.

In the present specification, “retentate” refers to substances remaining in the solvent phase without permeating the membrane in a membrane process and the solvent phase containing the same.

In the present specification, “buffer” refers to a solution added to the retentate phase to maintain the atmosphere such as pH and polymer concentration of the phase in order to carry out a diafiltration process.

In the present specification, “diavolume” is a dimensionless number that represents the ratio of the amount of a solution that has passed through a membrane used in diafiltration relative to the amount of the solution initially introduced into the process.

In the present specification, “decomplexation” means that each molecule or ion that is present in a complex due to chemical bonding or physical force is separated from each other and behaves independently.

In the present specification, “nanofiltration membrane” refers to a membrane with a pore size of less than 1 nm that suppresses the penetration of multivalent ions and allows monovalent ions to pass through by the sieving effect and electrostatic repulsion.

The method for selectively recovering and concentrating valuable metal ions according to an embodiment of the present invention comprises (1) adding a water-soluble polymer to a solution containing valuable metal ions and impurity metal ions to form a polymer-ion complex in which the valuable metal ions and the polymer are combined; (2) conducting diafiltration on the solution containing the polymer-ion complex and the impurity metal ions to have the impurity metal ions selectively penetrated and removed; (3) adding an acid to the polymer-ion complex solution from which the impurity metal ions have been removed to decomplex the water-soluble polymer and the valuable metal ions; (4) conducting diafiltration on the solution containing the water-soluble polymer and the valuable metal ions that have been decomplexed to have the valuable metal ions selectively penetrated and recovered; and (5) concentrating the recovered valuable metal ions through a nanofiltration process.

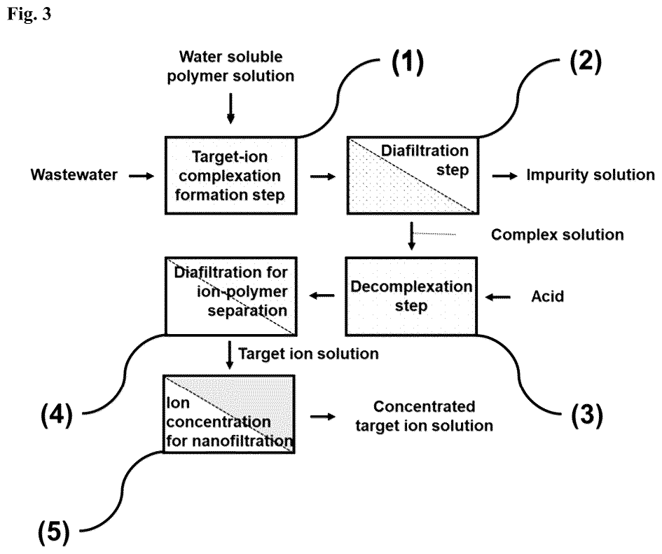

FIG. 3 is a flow chart of a method for recovering valuable metal ions from a solution according to an embodiment of the present invention. Hereinafter, referring to FIG. 3, each step of the method according to an embodiment of the present invention will be described.

Step (1)

In step (1), a water-soluble polymer is added to a solution containing valuable metal ions and impurity metal ions to form a polymer-ion complex in which the valuable metal ions and the polymer are combined.

In a specific embodiment of the present invention, the solution containing valuable metal ions and impurity metal ions may be a waste solution discharged from a manufacturing process of cathode material for secondary batteries, but it is not particularly limited thereto.

In a specific embodiment of the present invention, the valuable metal subject to recovery comprises at least one selected from the group consisting of nickel, cobalt, manganese, zinc, copper, iron, and cadmium, but it is not particularly limited thereto. In a preferred embodiment of the present invention, the valuable metal subject to recovery may comprise nickel.

In a specific embodiment of the present invention, the concentration of the valuable metal ions in the solution may be 50 ppm to 10,000 ppm, specifically 1,000 ppm to 5,000 ppm, but it is not particularly limited thereto. Even if the concentration of the valuable metal ions is outside the above range, the method according to an embodiment of the present invention can be used as long as it is a range in which a polymer-ion complex would not fully penetrate.

In a specific embodiment of the present invention, the impurity metal comprises at least one selected from the group consisting of lithium, sodium, potassium, magnesium, and calcium, but it is not particularly limited thereto. In a preferred embodiment of the present invention, the impurity metal may comprise sodium.

In a specific embodiment of the present invention, the concentration of the impurity metal ions in the solution may be 200 ppm to 100,000 ppm, specifically 2,000 ppm to 100,000 ppm, but it is not particularly limited thereto. Even when the concentration of the impurity metal ions in the solution is less than 200 pm or at a high concentration approaching solubility, the method according to an embodiment of the present invention can be used if the impurity metal ions follow convective transport within the pores of the separation membrane.

In a specific embodiment of the present invention, the water-soluble polymer may comprise at least one selected from the group consisting of polyethyleneimine (PEI), poly(vinyl alcohol) (PVA), poly(acrylic acid, sodium salt) (PAANa), poly(4-styrenesulfonic acid, sodium salt) (PSSNa), poly(vinylsulfonic acid, sodium salt) (PVSNa), and carboxymethyl cellulose (CMC), but it is not particularly limited thereto as long as it can form a complex with the valuable metal ions through coordination or electrostatic interaction.

In a specific embodiment of the present invention, the water-soluble polymer may have a weight average molecular weight ranging from 50 kDa to 500 kDa, but it is not particularly limited thereto.

In a specific embodiment of the present invention, the amount of the water-soluble polymer added relative to the content of the valuable metal ions is determined by their interaction. The amount of the water-soluble polymer added per 1 g of the valuable metal ions is preferably 5 g to 20 g. If the amount of the water-soluble polymer added is less than 5 g, the formation of a polymer-ion complex may not be sufficient. If the amount of the water-soluble polymer added exceeds 20 g, the viscosity of the solution may increase unnecessarily.

The polymer may be added in the form of a solid or a solution as dissolved in a solvent, in which case water is preferred as the solvent for the solution. Here, the concentration of the polymer solution may be 10% to 35% by weight, but it is not particularly limited thereto.

In a specific embodiment of the present invention, once the water-soluble polymer has been added to the solution, the solution is sufficiently stirred so that the valuable metal ions and the polymer can form a complex. The pH of the solution after stirring is preferably in the range of 6 to 11, but it is not particularly limited thereto. If the pH of the solution after the water-soluble polymer has been added is within the above range, a complex can be formed smoothly.

Step (2)

In step (2), the solution containing the polymer-ion complex and the impurity metal ions is filtered in a diafiltration mode to have the impurity metal ions selectively penetrated and removed.

The diafiltration is carried out using an ultrafiltration membrane that can have the impurity metal ions selectively penetrated and removed, leaving the polymer-ion complex as a retentate by a sieving effect that utilizes the difference in kinetic diameter between the polymer-ion complex and the impurity metal ions. Specifically, it is advantageous in selectively retaining the valuable metal-based complex by setting the molecular weight cutoff of the ultrafiltration membrane equal to, or less than, the molecular weight of the water-soluble polymer. Here, the molecular weight cutoff of the ultrafiltration membrane may be 1% to 100% of the molecular weight of the polymer.

The material of the ultrafiltration membrane may be freely selected within the scope that does not exceed the pH limit during diafiltration. Specifically, the ultrafiltration membrane may comprise at least one selected from the group consisting of polyethersulfone, polyvinylidene fluoride, and polysulfone, but it is not particularly limited thereto.

In a specific embodiment of the present invention, in order to stably carry out the diafiltration, it is desirable to use neutral distilled water as a buffer to ensure that the pH of the retentate is maintained stably.

In a specific embodiment of the present invention, the operating pressure and diavolume during diafiltration may be adjusted depending on the concentration of the polymer added in step (1) and the concentration of impurity metal ions. Specifically, during diafiltration, the operating pressure may be 0.5 bar to 10 bar, and the diavolume may be 2 to 10, but they are not particularly limited thereto.

Step (3) in step (3), an acid is added to the polymer-ion complex solution from which the impurity metal ions have been removed to decomplex the water-soluble polymer and the valuable metal ions.

In a specific embodiment of the present invention, the acid may comprise at least one selected from the group consisting of sulfuric acid (H₂SO₄), hydrochloric acid (HCl), and nitric acid (HNO₃), but it is not particularly limited thereto. Here, it is desirable to select the type of the acid in light of the counter ions of the valuable metal ions.

In a specific embodiment of the present invention, the acid is preferably added in the form of an aqueous solution at a concentration of 0.1 M to 1 M, but it is not particularly limited thereto.

In a specific embodiment of the present invention, the pH of the polymer-ion complex solution after the acid has been added is desirably in the range of 1 to 3, but it is not particularly limited thereto. If the pH of the polymer-ion complex solution after the addition of the acid is within the above range, the polymer-ion complex can be properly decomplexed into the polymer and the valuable metal ions.

Step (4)

In step (4), the solution containing the water-soluble polymer and the valuable metal ions that have been decomplexed is filtered in a diafiltration mode to have the valuable metal ions selectively penetrated and recovered.

The diafiltration is carried out using an ultrafiltration membrane that can have the valuable metal ions selectively penetrated and recovered, leaving the polymer as a retentate by a sieving effect that utilizes the difference in kinetic diameter between the polymer and the valuable metal ions. Specifically, it is advantageous for having the valuable metal ions selectively penetrated by setting the molecular weight cutoff of the ultrafiltration membrane equal to, or less than, the molecular weight of the water-soluble polymer. Here, the molecular weight cutoff of the ultrafiltration membrane may be 1% to 100% of the molecular weight of the polymer.

The material of the ultrafiltration membrane may be substantially the same as that used in step (2) above.

In a specific embodiment of the present invention, in order to stably carry out the diafiltration, it is desirable to use the same aqueous acid solution used in step (3) above as a buffer. Here, the pH of the aqueous acid solution used as a buffer is preferably substantially the same as the pH of the solution containing the water-soluble polymer and the valuable metal ions that have been decomplexed.

In a specific embodiment of the present invention, the operating pressure and diavolume during diafiltration may be freely adjusted depending on the concentration of the target ions or water permeance. Specifically, the operating pressure during diafiltration may be substantially the same as the operating pressure during diafiltration in step (2) above. In addition, the diavolume during diafiltration may be 2 to 7. But they are not particularly limited thereto. Step (5)

In step (5), the recovered valuable metal ions are concentrated through a nanofiltration process.

The material of the nanofiltration membrane used in step (5) may be freely selected as long as it is a membrane that can withstand the pH conditions of the solution containing the valuable metal ions recovered in step (4).

The operating pressure during the concentration step may be freely determined depending on the final target concentration of the valuable metal ions solution. Specifically, during diafiltration, the operating pressure may be 10 bar to 30 bar, but it is not particularly limited thereto.

### EXAMPLE

Hereinafter, the present invention will be described in more detail with reference to Examples. However, the following examples are for illustrative purposes only and are not intended to limit the scope of the present invention.

### Example 1

(1) Formation of a Polymer-Ion Complex

10 g of polyethyleneimine with a weight average molecular weight of 70 kDa was added per liter of a mixed solution of nickel sulfate and sodium sulfate with a nickel ion concentration of 1,000 ppm and a sodium ion concentration of 10,000 ppm. Thereafter, the solution was stirred at room temperature for 30 minutes at 200 rpm. The pH of the solution after stirring was 10. The concentration of metal ions in the solution was measured using inductively coupled plasma (ICP). Here, the ICP equipment used was Thermo iCAP 7000 Series ICP-OES, and measurements were made under the conditions of element detection set wavelengths: Ni: 589.592 nm and Na: 231.604 nm.

(2) Diafiltration for Removing the Impurity Metal Ions

The solution containing the polymer-ion complex formed above was fed to a diafiltration device equipped with a polyethersulfone ultrafiltration membrane having a molecular weight cutoff of 10 kDa. Here, diafiltration was carried out at a pressure of 8 bar until the diavolume reached 9. In order to carry out stable diafiltration, neutral distilled water was used as a buffer to ensure that the pH of the retentate was maintained stably.

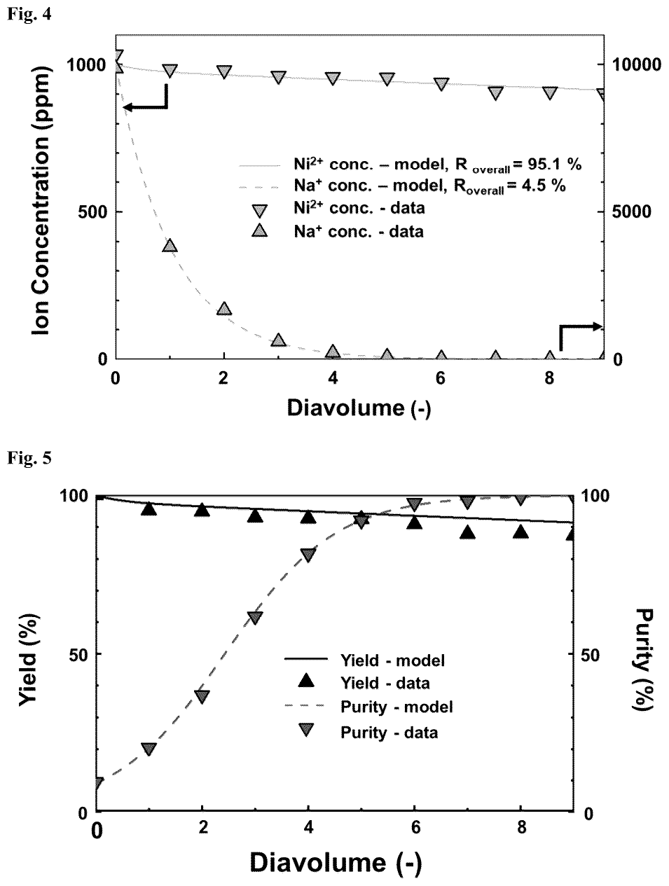

The concentrations of nickel and sodium in the salt solution collected through the formation of the polymer-ion complex and the diafiltration to remove the impurity metal ions, the concentrations of nickel and sodium in the solution containing the polymer-ion complex after the water-soluble polymer solution was added, and the concentrations of nickel and sodium in the retentate after each step were measured using inductively coupled plasma (ICP). As a result, as shown in FIG. 4, sodium at a concentration of 9,860 ppm or more in the polymer-ion complex solution was removed to a level of 1.68 ppm through diafiltration, while the concentration of nickel was slightly decreased from 1,033 ppm to 902 ppm.

In addition, the purity and yield of nickel at each diavolume were calculated using the following equations and are shown in FIG. 5.

C_{feed,initial}=C_{feed,1} [Equation 1]

C_{feed,n}=C_{retentate,n-1}=C_{feed,initial}−Σᵢ₌₁ⁿ⁻¹C_{permeate,n} [Equation 2]

Purity ata diavolume ofn (%)=[C_{Ni,retentate,n}/(C_{Ni,retentate,n}+C_{Na,retentate,n})]×100 [Equation 3]

Yield ata diavolume ofn (%)=C_{retentate,n}/C_{feed,initial}×100 [Equation 4]

In the above equations,
n=diavolume
C_{feed, initial}=concentration (ppm) of the polymer-ion complex solution at the initial state of diafiltration,
C_{feed, n}=concentration (ppm) of the polymer-ion complex solution at a diavolume of n,
C_{retentate, n}=concentration (ppm) of the retentate at a diavolume of n,
C_{Ni, retentate, n}=concentration (ppm) of Ni in the retentate at a diavolume of n,
C_{Na, retentate, n}=concentration (ppm) of Na in the retentate at a diavolume of n,
C_{permeate, n}=concentration (ppm) of the permeate at a diavolume of n.

(3) Decomplexation of the Polymer-Ion Complex

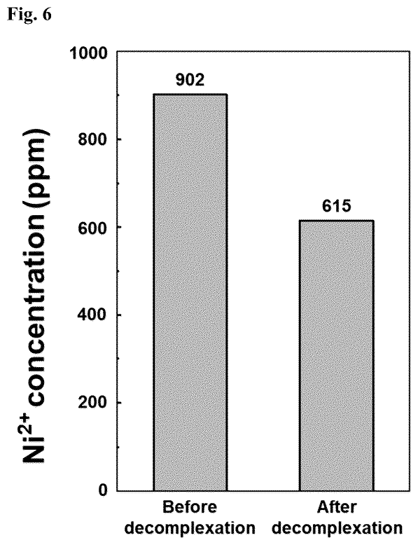

A 0.1 M sulfuric acid solution was added to the solution from which most of the sodium ions had been removed through the diafiltration. Thereafter, the solution was stirred at room temperature for 30 minutes at 200 rpm. The pH of the solution was adjusted to 3 upon the addition of the solution. As a result of the measurement of the concentration of nickel using ICP, the concentration of nickel in the solution in which the polymer-ion complex had been decomplexed was diluted from 902 ppm to 615 ppm (see FIG. 6).

(4) Diafiltration for Recovering the Valuable Metal Ions

The solution in which the polymer-ion complex had been decomplexed above was fed to a diafiltration device equipped with a polyethersulfone ultrafiltration membrane having a cutoff molecular weight of 10 kDa. Here, diafiltration was carried out at a pressure of 8 bar until the diavolume reached 5. In order to carry out stable diafiltration, an aqueous sulfuric acid solution with a pH of 3 was used as a buffer to ensure that the decomplexed state of the polymer-ion complex could be maintained continuously during the diafiltration process.

The concentration of nickel in the solution initially fed and in the permeate at each diavolume was measured using ICP. The change in concentration of the total permeate that passed through the membrane with respect to diavolume was measured.

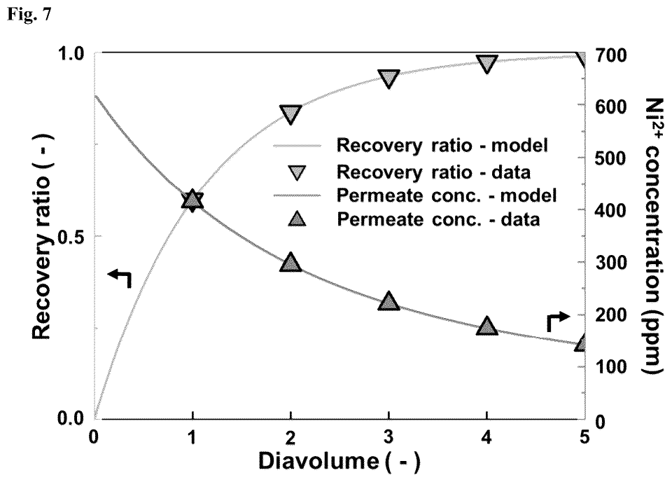

As a result, although the concentration of the nickel solution that passed through the membrane was diluted to 142 ppm, 98.9% of nickel was recovered relative to the amount of nickel in the solution (see FIG. 7).

(5) Concentration of the Valuable Metal Ion Solution Using a Nanofiltration Membrane

The high-purity, low-concentration nickel solution recovered above was fed to a nanofiltration device equipped with a fully crosslinked aromatic polyamide nanofiltration membrane. Here, the nanofiltration was carried out at 15 bar.

The concentration of nickel was measured using ICP as the solution was concentrated.

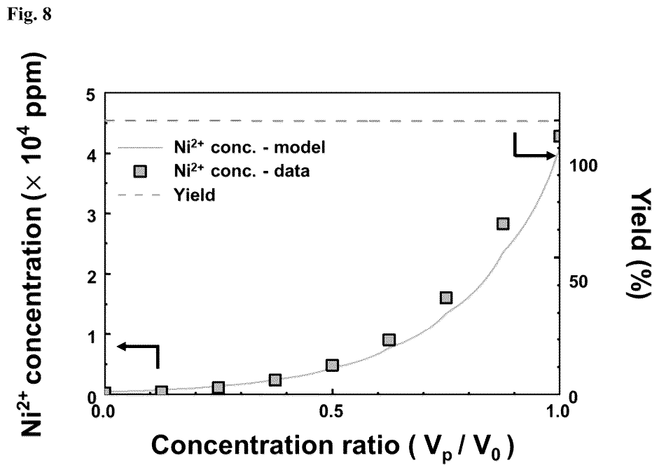

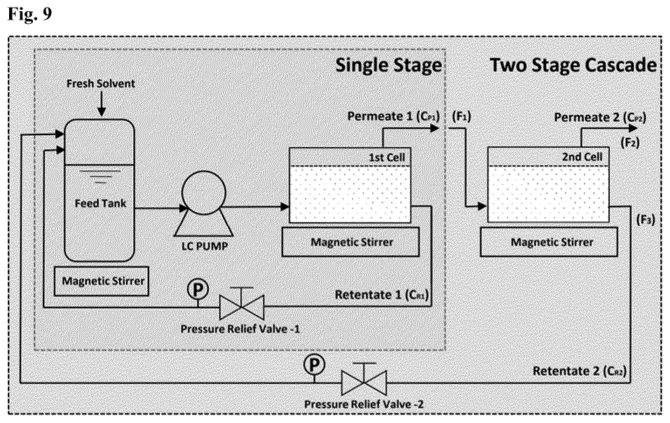

Finally, as shown in FIG. 8, the nickel solution recovered in step (4) was concentrated to 42,830 ppm with a recovery rate of 99%.

In conclusion, 85.8% of the nickel in the input waste solution could be recovered with a purity of 99.8% through the entire process from steps (1) to (5).

### Example 2 (Experiment and Simulation)

A solution was prepared in which one of nickel, cobalt, copper, and cadmium as a valuable metal and one of lithium, sodium, potassium, and magnesium as an impurity metal were paired in the same molar composition ratio as the nickel-sodium waste solution of Example 1. The rejection of the diafiltration membrane for the solution was measured using a dead end filtration method. The rejection of each ion is shown in Tables 1 and 2.

R_{i,obs}=1−C_{i,permeatc}/C_{i,retentate} [Equation 5]
C_{i, permeate}=concentration (ppm) of ion i in the permeate
C_{i, retentate}=concentration (ppm) of ion i in the retentate

TABLE 1

| Rejection (%) | Li⁺ | Na⁺ | K⁺ | Mg²⁺ |
|---|---|---|---|---|
| Ni²⁺ | 96.6 | 95.9 | 95.9 | 88.4 |
| Co²⁺ | 68.7 | 82.1 | 88.5 | 66.6 |
| Cu²⁺ | 96.5 | 95.5 | 95.9 | 96.2 |
| Cd²⁺ | 96.3 | 95.3 | 95.8 | 96.3 |

TABLE 2

| Rejection (%) | Li⁺ | Na⁺ | K⁺ | Mg²⁺ |
|---|---|---|---|---|
| Ni²⁺ | 3.62 | 5.63 | 4.27 | 1.26 |
| Co²⁺ | 6.67 | 3.40 | 1.66 | 4.04 |
| Cu²⁺ | 3.56 | 3.99 | 3.31 | 4.75 |
| Cd²⁺ | 2.10 | 2.74 | 1.53 | 6.59 |

Based on the measured rejection, the yield and purity of the valuable metals from each solution in the cascade system shown in FIG. 11 were predicted using MATLAB (see Tables 3 and 4). The equations used are as follows.

dmᵣₑₜₑₙₜₐₜₑ/dt=Jᵥ×A×C_{i,retentate}×(1−R) [Equation 6]

C_{i,retentate}/C_{i,retentate,initial}=exp[−Jᵥ×A×t/V×(1−R)]=exp[−Diavolume×(1−R)] [Equation 7]

dm_{i,retentate,1}=[−F₁×C_{i,rentate,1}×(1−R_{i,1})+F₃×C_{i,retentate,2}] [Equation 8]

dm_{i,retentate,2}=[F₁×C_{i,rentate,1}×(1−R_{i,1})−F₂×C_{i,retentate,2}(1−R_{i,2})−F₃×C_{i,retentate,2}] [Equation 9]

Yield (%)=m_{i,retentate,final}/M_{i retentate,initial}×100% [Equation 10]

Purity (%)=m_{valuable metal,retentate}/(m_{valuable metal,retentate}+m_{impurity metal,retentate}) [Equation 11]

For calculations for two diafiltration steps, the following equation is applied.

dV/dt=0 [Equation 12]

In the above equation,
M_{I,retentate}=mass of ion i in the retentate
Jᵥ=flow rate of the membrane (L m⁻² h⁻¹)
A=area of the membrane (m²)
C_{i,permeate,n}=concentration of ion i in the n-stage membrane permeate (g L⁻¹)
C_{i,retentate,n}=concentration of ion i in the n-stage membrane retentate (g L⁻¹)
C_{i,retentate, initial}=concentration of ion i at the beginning of the membrane retentate (g L⁻¹)
t=operation time (h)
V=volume of the system (L)
Diavolume=diavolume
F=flow rate (L h⁻¹)
R=rejection

TABLE 3

| Yield (%) | Li⁺ | Na⁺ | K⁺ | Mg²⁺ |
|---|---|---|---|---|
| Ni²⁺ | 93.3 | 89.8 | 91.9 | 69.5 |
| Co²⁺ | 21.5 | 50.3 | 70.3 | 18.6 |
| Cu²⁺ | 93.2 | 91.0 | 92.0 | 92.6 |
| Cd²⁺ | 92.8 | 90.2 | 91.5 | 92.6 |

TABLE 4

| Purity (%) | Li⁺ | Na⁺ | K⁺ | Mg²⁺ |
|---|---|---|---|---|
| Ni²⁺ | 99.8 | 99.8 | 99.8 | 99.8 |
| Co²⁺ | 99.1 | 99.7 | 99.8 | 99.1 |
| Cu²⁺ | 99.8 | 99.8 | 99.8 | 99.8 |
| Cd²⁺ | 99.9 | 99.8 | 99.9 | 99.8 |

The yield (89.8%) and purity (99.8%) predicted for the nickel and sodium mixed waste solution were almost identical to the yield (85.8%) and purity (99.8%) in Example 1, confirming the reliability of the predicted values.

According to an embodiment of the present invention, it has a great advantage in that not only can the efficiency of the resource recycling process be enhanced by selectively recovering and concentrating valuable metal ions from a solution, but the purity of the product obtained through resource recycling can also be greatly enhanced.

### EXPLANATION OF REFERENCE NUMERALS

(1) Formation of a polymer-ion complex; (2) removal of impurity metal ions; (3) decomplexation of the polymer-ion complex; (4) Recovery of valuable metal ions; (5) concentration of valuable metal ion solution.

What is claimed is:

1. A method for selectively recovering and concentrating valuable metal ions, which comprises (1) adding a water-soluble polymer to a solution containing valuable metal ions and impurity metal ions to form a polymer-ion complex in which the valuable metal ions and the polymer are combined; (2) conducting diafiltration on the solution containing the polymer-ion complex and the impurity metal ions to have the impurity metal ions selectively penetrated and removed; (3) adding an acid to the polymer-ion complex solution from which the impurity metal ions have been removed to decomplex the water-soluble polymer and the valuable metal ions; (4) conducting diafiltration on the solution containing the water-soluble polymer and the valuable metal ions that have been decomplexed to have the valuable metal ions selectively penetrated and recovered; and (5) concentrating the recovered valuable metal ions through a nanofiltration process.

2. The method for selectively recovering and concentrating valuable metal ions of claim 1, wherein the solution in step (1) is a waste solution discharged from a manufacturing process of cathode material for secondary batteries.

3. The method for selectively recovering and concentrating valuable metal ions of claim 1, wherein the valuable metal in the solution of step (1) comprises at least one selected from the group consisting of nickel, cobalt, manganese, zinc, copper, iron, and cadmium.

4. The method for selectively recovering and concentrating valuable metal ions of claim 1, wherein the concentration of the valuable metal ions in the solution of step (1) is 50 ppm to 10,000 ppm.

5. The method for selectively recovering and concentrating valuable metal ions of claim 1, wherein the impurity metal in the solution of step (1) comprises at least one selected from the group consisting of lithium, sodium, potassium, magnesium, and calcium.

6. The method for selectively recovering and concentrating valuable metal ions of claim 1, wherein the concentration of the impurity metal ions in the solution of step (1) is 200 ppm to 100,000 ppm.

7. The method for selectively recovering and concentrating valuable metal ions of claim 1, wherein the water-soluble polymer in step (1) comprises at least one selected from the group consisting of polyethyleneimine (PEI), poly(vinyl alcohol) (PVA), poly(acrylic acid, sodium salt) (PAANa), poly(4-styrenesulfonic acid, sodium salt) (PSSNa), poly(vinylsulfonic acid, sodium salt) (PVSNa), and carboxymethyl cellulose (CMC).

8. The method for selectively recovering and concentrating valuable metal ions of claim 1, wherein the water-soluble polymer is step (1) has a weight average molecular weight ranging from 50 kDa to 500 kDa.

9. The method for selectively recovering and concentrating valuable metal ions of claim 1, wherein the amount of the water-soluble polymer added per 1 g of the valuable metal ions in step (1) is 5 g to 20 g.

10. The method for selectively recovering and concentrating valuable metal ions of claim 1, wherein the pH of the solution is in the range of 6 to 11 after the water-soluble polymer is added to the solution and the solution is stirred in step (1).

11. The method for selectively recovering and concentrating valuable metal ions of claim 1, wherein the ultrafiltration membrane in each of steps (2) and (4) comprises at least one selected from the group consisting of polyethersulfone, polyvinylidene fluoride, and polysulfone.

12. The method for selectively recovering and concentrating valuable metal ions of claim 1, wherein the molecular weight cutoff of the ultrafiltration membrane in each of steps (2) and (4) is 1% to 100% of the molecular weight of the polymer.

13. The method for selectively recovering and concentrating valuable metal ions of claim 1, wherein neutral distilled water is used as a buffer during diafiltration in step (2).

14. The method for selectively recovering and concentrating valuable metal ions of claim 1, wherein the acid in step (3) comprises at least one selected from the group consisting of sulfuric acid, hydrochloric acid, and nitric acid.

15. The method for selectively recovering and concentrating valuable metal ions of claim 1, wherein the acid is added in the form of an aqueous solution at a concentration of 0.1 M to 1 M in step (3).

16. The method for selectively recovering and concentrating valuable metal ions of claim 1, wherein the pH of the polymer-ion complex solution after the acid has been added is in the range of 1 to 3 in step (3).

17. The method for selectively recovering and concentrating valuable metal ions of claim 1, wherein the same aqueous acid solution used in step (3) is used as a buffer during diafiltration in step (4), and the pH of the buffer is the same as the pH of the solution containing the water-soluble polymer and the valuable metal ions that have been decomplexed in step (3).

18. The method for selectively recovering and concentrating valuable metal ions of claim 1, wherein the operating pressure in step (5) is 10 bar to 30 bar.
